(19) United States
(12) Patent Application Publication
(10) Pub. No.: US 2008/0196748 A1
(43) Pub. Date: Aug. 21, 2008

(54) System and Method for Cleaning Process Trays

(75) Inventor: Patrick J. Tobin, Waterford (IE)

Correspondence Address: Bausch & Lomb Incorporated, One Bausch & Lomb Place, Rochester, NY, 14604-2701, US

(73) Assignee: BAUSCH & LOMB INCORPORATED, Rochester, NY (US)

(21) Appl. No.: 12/025,199

(22) Filed: Feb. 4, 2008

(30) Foreign Application Priority Data
Feb. 15, 2007 (IE) 2007/0096

(51) Int. Cl. B08B 3/02

(52) U.S. Cl. 134/32; 134/34

(57) ABSTRACT

An electronically controlled programmable system and method for removing debris such as stray contact lenses adhered to process trays. A combination of low and high pressure aqueous sprays is applied to surfaces of a process tray to be cleaned thereby disturbing and removing stray lenses adhered to the tray. The sprays also hydrate dried contact lenses to assist in breaking their adhesive bond to the tray. After removal of stray lenses the system washes and rinses the trays using filtered mains water, purified or distilled water. Trays are automatically loaded and unloaded to and from a cleaning zone within the system.

### BACKGROUND OF THE INVENTION

1. Technical Field

This present invention relates to a system and a method for cleaning process trays such as but not limited to trays for handling small light objects like ophthalmic lenses which are otherwise difficult to detect visually.

2. Description of Related Art

Typically, the technological process of manufacture of contact lenses or intraocular lenses involves operations of extraction, hydration and/or coating of the lenses and sterilisation. For productivity purposes, it is most desirable that these operations are carried out on batches of lenses. Therefore, process trays are used to hold and transport a plurality of cured lenses. One such tray is described in U.S. Pat. No. 6,581,761 (Stafford et al) and comprises a wire mesh insert with a plurality of receptacles for holding individual lenses. Various other tray configurations may also be used.

The operation of extraction involves removal of undesirable materials which may migrate into the lens during moulding or removal of unreacted monomers or partially reacted oligomers which remain in the lens after polymerisation. During hydration dry lenses are immersed in water or aqueous solution in order to absorb as much water as their formulation allows. During the above operations, fluid circulates around the lenses and moistens them. Trays may be used to facilitate handling of lenses during such extraction and/or hydration. In some cases, the lens may be surface treated or coated, in which case trays also may be used to hold or transport the lenses.

After each operation is completed, the batch of lenses is removed from the tray and the tray is re-cycled to process another batch of lenses. These trays must be maintained pristine clean so that the optical quality of the lenses handled by the trays is not compromised. However, some moistened stray lenses may adhere to tray surfaces and remain on the tray after the batch has been removed. If a stray lens dries while adhered to the tray, the adhesion force may be strong making it rather difficult to remove the stray lens. Some trays can have complex shapes which makes stray lenses even more difficult to remove if the lenses are trapped in awkward places. These stray lenses, if remaining on the tray when the tray is re-cycled for another batch of lenses, can compromise the quality of the lenses of this next batch.

The existing process for removing stray lenses from process trays involves an operator manually washing the trays over a sink. The operator normally uses purified water from a hose to wash the trays. This known process has been found not to be consistent due to operator's variability. Also, relatively high volumes of purified water are consumed. Furthermore, the use of the manual labour renders the process expensive.

Consequently, there remains a need for an improved system and method for cleaning process trays and removing wet or dry stray lenses therefrom. An object of the present invention is to obviate and/or mitigate the above discussed problems of the prior art.

### SUMMARY OF THE INVENTION

Accordingly, the invention provides system for removing debris such as stray contact lenses adhered to process trays comprising:
a first and a second spray means for supplying aqueous spray, each of the first and second spray means being positionable in the proximity of a process tray to be cleaned;
a first regulation means for regulating the pressure of the aqueous spray supplied by the first spray means so that the aqueous spray is applied to the tray at a first lower pressure;
a second regulation means for regulating the pressure of the aqueous spray supplied by the second spray means so that the aqueous spray is applied to the tray at a second higher pressure;
the combination of the lower pressure and higher pressure sprays being sufficient to disturb and remove debris, such as stray contact lenses adhered to the tray.

Advantageously, the lower pressure spray is sufficient to hydrate dried debris adhered to the tray thereby assisting in breaking the adhesion between the debris and the tray.

The system is most suitable to, but not limited to handling contact lens handling trays having complex-shaped plastic inserts or wire-mesh construction. Such and other trays typically comprise a pair of opposing flat surfaces, namely a first working surface and a second back surface.

In one embodiment, each of the first and second spray means comprises at least one nozzle. In a preferred embodiment, the first spray means comprises a plurality of nozzles, the number of the nozzles being sufficient to provide for access of the sprays to all areas of the tray which require cleaning. Ideally, the plurality of nozzles of the first spray means is provided at each of a pair of opposing sides of the tray. Optionally, at least one of the first and second spray means may be movable so as to ensure access by the sprays to all the areas of the tray which require spraying

In a preferred arrangement, the second spray means comprises a first nozzle positionable adjacent a first side of the tray and a second nozzle positionable adjacent a second side of the tray.

In a most preferred arrangement, the system comprises a conveyor movable through a cleaning zone of the system. Ideally, the conveyor is continuously movable through the cleaning zone of the system during cleaning of trays. In one arrangement, the conveyor may comprise a tray support means for placing a tray onto the conveyor in an upright orientation.

The system of the invention may be provided with an electronically controlled robot means for loading and unloading process trays onto and from the conveyor.

Preferably, the system comprises a first source of aqueous medium operable to wash the trays in accordance with a pre-determined washing cycle after removal of the debris and a third pressure regulating means for regulating the pressure of the aqueous medium so that the aqueous medium is applied to the tray at a third lower pressure.

The first source of aqueous medium is preferably positioned with respect to the tray so that the aqueous medium is applied to the tray at an uppermost region thereof so as subsequently to flow along surfaces of the tray under gravity (i.e. in a “waterfall flood” manner) towards lower regions of the tray thereby removing any particles or contaminants which may have attached to the tray during upstream processes.

Optionally, the first source of aqueous medium may be controllably movable so as to ensure access by the sprays to all the areas of the tray which require washing.

A further preferred feature of the system is a second source of an aqueous medium operable to rinse the trays in accordance with a pre-determined rinsing cycle and a fourth pressure regulating means for regulating the pressure at which the aqueous medium is applied to the tray so that the aqueous medium is applied to the tray with a fourth lower pressure thereby eliminating any contaminants which remain on the tray after the upstream process steps. Optionally, the second source of aqueous medium may be controllably movable so as to ensure access by the sprays to all the areas of the tray which require rinsing.

Preferably, the first source of aqueous medium is adapted to supply relatively larger quantities of the aqueous medium and the second source of aqueous medium is adapted to supply relatively smaller quantities of the aqueous medium. The second source may also be adapted to supply the aqueous medium in the form of low pressure pulsatory jets.

In one arrangement, the first and second sources of aqueous medium comprise at least one nozzle. In another arrangement, each or one of the first and second sources of aqueous medium comprises a plurality of nozzles, the number of the nozzles being sufficient to provide for access of the aqueous medium to all areas of the tray which require cleaning. The plurality of the nozzles may be provided at each of a pair of opposing sides of the tray.

In a most preferred embodiment, the system comprises at least one programmable electronic controller adapted to control at least one and preferably all of the first and second spray pressure regulating means and the third and fourth aqueous medium pressure regulating means. Preferably, the programmable electronic controller is adapted to control the system in accordance with a pre-determined cleaning cycle.

It is desirable to subject the aqueous medium used in the rinsing cycle to a treatment, such as but not limited thereto, a purification process, so as to render the aqueous medium free from minerals, dissolved gases and/or biological contaminants. During the steps of spraying and washing the trays an aqueous medium such as filtered mains water may be utilised.

In one modification, the first lower spray pressure and the third and fourth aqueous medium pressures may be each about 0.14-0.7 MPa (20-100 psi) and preferably about 0.4 MPa (60 psi), and the second higher spray pressure may be about 1.4-8.3 MPa (200-1200 psi) and preferably about 4 MPa (600 psi).

In a preferred embodiment, the first spray means, the second spray means, the first source of aqueous spray and the second source or aqueous spray are located at first, second, third and fourth locations, respectively spaced from each other along the conveyor.

An advantageous feature of the system is a collector manifold for collecting used aqueous medium, the collector manifold being connected to an overflow reservoir for receiving the used aqueous medium, the reservoir being connected to a supply of fresh aqueous medium so that the used and the fresh aqueous media mix in the reservoir, and the reservoir having an open section at a top portion thereof so that excess aqueous medium can exit the reservoir through the open section, the reservoir being connected to a return manifold for recycling the aqueous medium during a subsequent cleaning cycle. The collector monitor may comprise a filter to remove from the used aqueous medium any debris collected by it during upstream processes.

In another aspect, the invention provides a method of removing debris such as stray contact lenses adhered to process trays comprising the steps of:
a. directing aqueous spray supplied from a first spray means at a first lower pressure towards surfaces of a process tray to be cleaned;
b. directing aqueous spray supplied from a second spray means at a second higher pressure towards surfaces of a process tray to be cleaned;
c. disturbing and removing debris such as stray contact lenses adhered to the tray with the combination of the lower-pressure and the higher-pressure aqueous sprays away from the tray.
   Ideally, the quality of the mix of fresh and used medium is controlled in the reservoir.

### BRIEF DESCRIPTION OF THE DRAWINGS

The invention will hereinafter be more particularly described with reference to the accompanying drawings which show, by way of example only, an embodiment of the present invention.

In the drawings:—

FIG. 1 is schematic plan view of an embodiment of a system in accordance with the invention;

FIG. 2 is an expanded portion of FIG. 1 showing a cleaning area of the system of the invention;

FIGS. 3a and 3b are perspective views of a process tray comprising a pair of plates for carrying complex-shaped plastic inserts;

FIGS. 4a, 4b and 4c are top, side and bottom views, respectively of a plate of a tray of FIGS. 3a and 3b adapted for carrying female plastic inserts; and

FIGS. 5a, 5b and 5c are top, side and bottom views, respectively of a plate of a tray of FIGS. 3a and 3b adapted for carrying male plastic inserts.

### DETAILED DESCRIPTION OF THE PREFERRED EMBODIMENTS

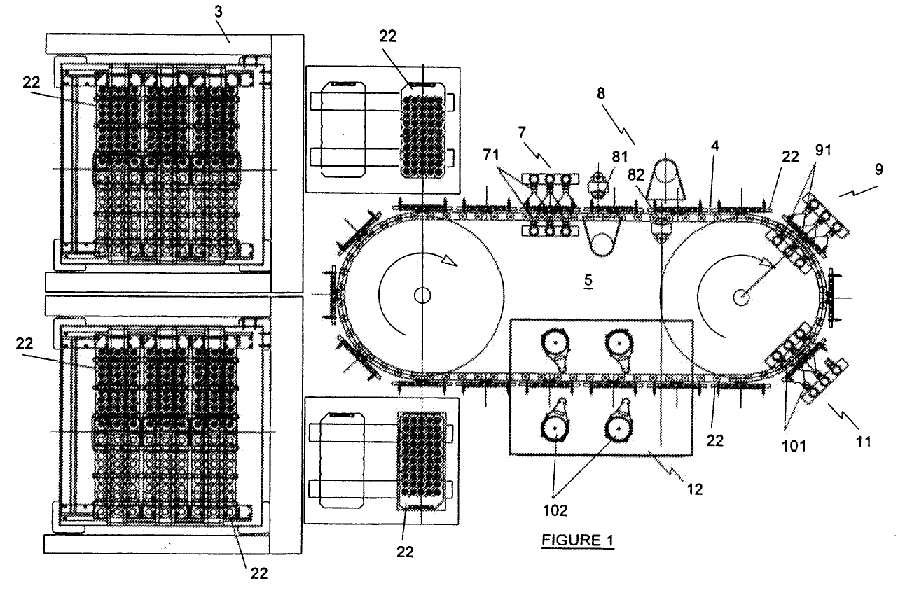

The cleaning system of the invention is generally indicated by reference numeral 1 in FIG. 1. The system 1 is most suitable to, but not limited to handling contact lens handling trays having complex-shaped plastic inserts or wire-mesh construction.

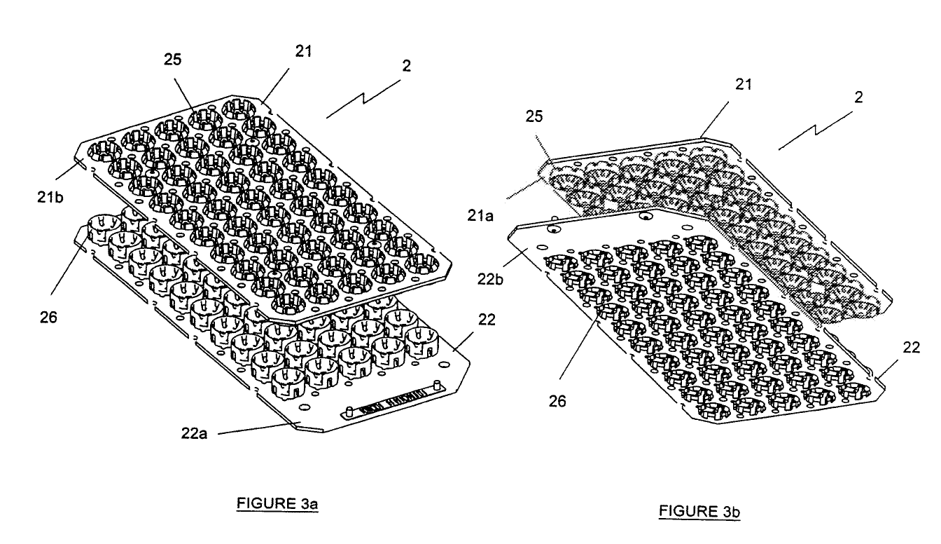

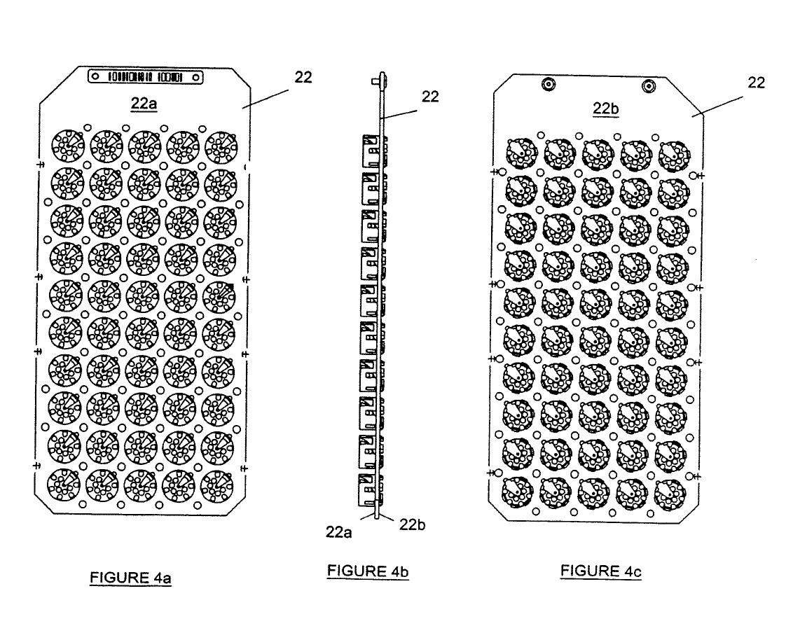

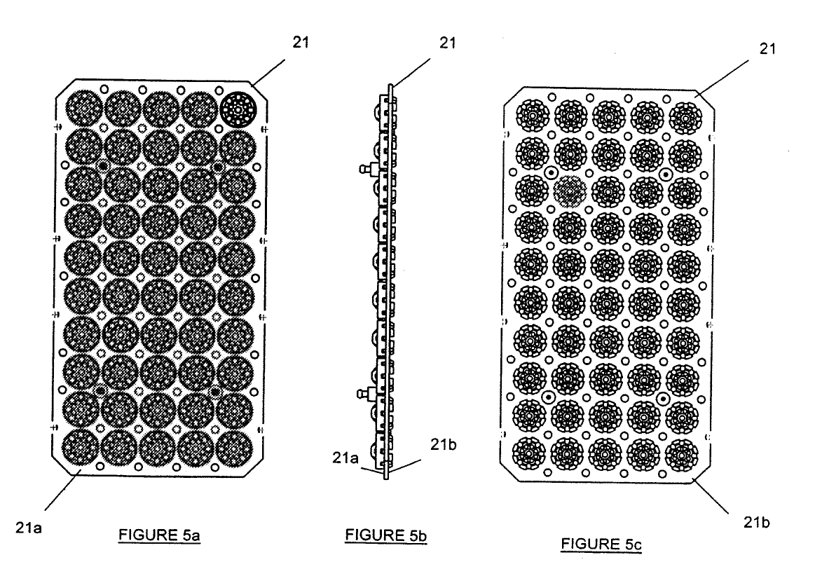

An example of a tray assembly 2 comprising a pair of plastic plates 21 and 22 is shown in FIGS. 3a and 3b. Plate 21 is adapted to carry a plurality of complex-shaped plastic male inserts 25. Plate 22 is adapted to carry a plurality of complex-shaped plastic female inserts 26. Prior to cleaning, plates 25, 26 are held together during various upstream processes, including lens-forming, so that convex surfaces 25a of the male inserts 25 face concave surfaces 26a of the female inserts 26. During those upstream processes, stray lens may adhere to any part of the plates 21, 22. For the cleaning step (to be described below in detail), the plates 21, 22 are separated from each other for individual handling during cleaning. Each plate 21, 22 comprises a pair of opposing surfaces, a first surface 21a, 22a and a second surface 21b, 22b, respectively (see also FIGS. 4a-4c and 5a-5c).

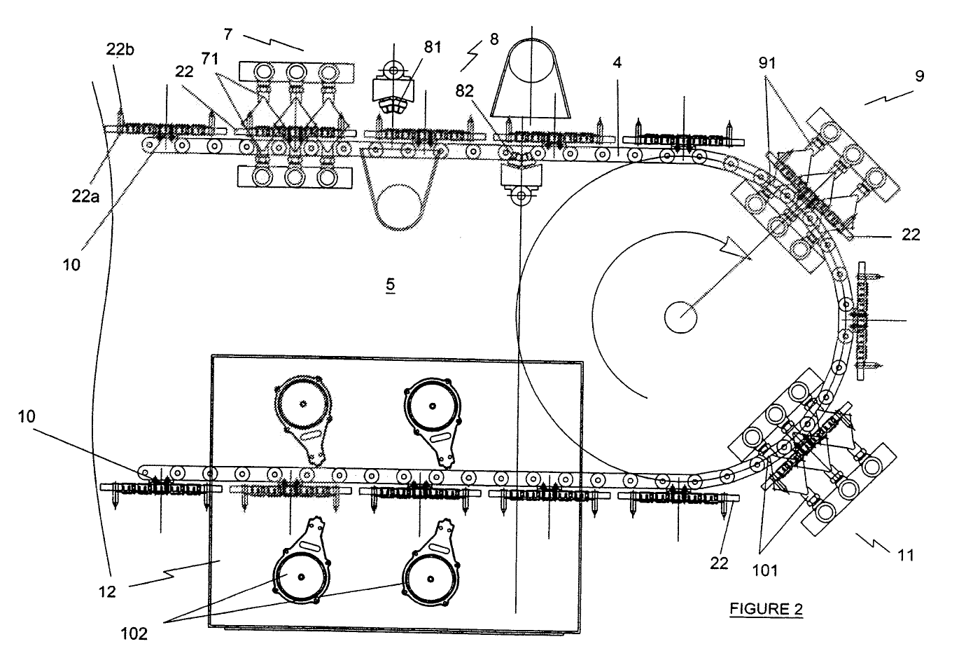

Plates 21, 22 to be cleaned together with the plastic inserts 25, 26, respectively are loaded to and unloaded from process carts 3 onto supports 10 (FIG. 2) located on a conveyor 4 movable through a cleaning area 5 of the system. The system 1 will be described below in connection with cleaning of a female insert bearing plate 25 as an example. It will be appreciated however that the system is equally suitable for cleaning various other known types of trays.

Plates 22 are held by the supports 10 in an upright orientation so that the opposing surfaces 22a and 22b face substantially sideways relative the direction of travel of the conveyor. The conveyor 4 preferably moves continuously through the cleaning area 5 during operation of the system 1. The loading and unloading of the plate 22 may be carried out either automatically using a programmable robot (not shown) or manually. The system 1 is electronically controlled by a programmable electronic controller (not shown) to operate automatically in accordance with a pre-determined cleaning cycle.

The system 1 comprises first and second spraying stations 7 and 8, a washing station 9, a rinsing station 11 and a drying station 12 positioned in sequence along the conveyor 4 so that the conveyor passes though an active zone of each station.

The first spraying station 7 has a plurality of nozzles 71 for supplying aqueous spray towards surfaces of a process plate 22 to be cleaned. In a preferred arrangement, as shown in FIGS. 1 and 2, the nozzles 71 are provided at each side of the conveyor 4 to enable cleaning of both sides 22a and 22b of the plate 22 simultaneously. The nozzles 71 are activated when a plate 22 moved by the conveyor 4 enters a space defined between the nozzles 71 and de-activated when the tray exits the space.

The second spraying station 8 is located downstream of the first spraying station 7. The second spraying station 8 comprises at least a pair of nozzles 81 and 82. A first nozzle 81 is placed at one side of the conveyor and sprays a first side, e.g. 22b, of a plate 22 entering the second spraying station 8. A second nozzle 82 is located downstream of the first nozzle 81 at the other side of the conveyor 4 and sprays a second side, e.g. 22a, of the plate 22. Each nozzle 81, 82 is movable under the control of the programmable controller so as to enable the sprays to access all the areas of the plate which require cleaning. In practice, as a plate 22 moves relative to each nozzle 81, 82, the relevant nozzle moves along a vertical path perpendicular the direction of travel of the conveyor 4 and parallel to the sides 22a and 22b of the plate 22, this relative motion of the plate and the nozzles resulting in the nozzles passing over all surfaces of the plate 22.

The pressures of the aqueous sprays produced by the first and second stations are regulated by the electronic programmable controller and the spray pressure of each spraying station 7, 8 is maintained at a pre-determined level. The pressure of the sprays produced at the first spraying station 7 is lower than the pressure of the spray of the second station 8 and is between 0.14-0.7 MPa (20-100 psi) and preferably about 0.4 MPa (60 psi). The pressure of the spray produced at the second station 8 is higher than the pressure of the spray of the first station 7 and is between 1.4-8.3 MPa (200-1200 psi) and preferably about 4 MPa (600 psi). The combination of such low and high pressure sprays is sufficient to disturb stray contact lenses adhered to surfaces of a process plate 22 being cleaned and to remove the stray lenses away from the plate in the waste cleaning liquid. The sprays of the first and second stations 7, 8 are also effective for removing other forms of debris, such as excess monomer or polymer remaining from an upstream lens-forming step or general industrial dirt from the plate. Some stray lenses may have dried onto the plate. The adhesion force may be strong, making the stray lens very difficult to remove. The sprays produced at the first station 7 hydrate the dried stray lenses thereby disrupting the bond between the lens and the tray and thereby assisting in subsequent removal of the lens by the higher pressure sprays produced at the second spraying station 8. Thus, the system of the present invention ensures quick and efficient removal of stray lenses even from awkward places of complex shaped plates or trays.

The washing station 9 is located downstream of the second spraying station 8. The washing station 9 has a plurality of nozzles 91 provided at each side of the conveyor 4 for washing both sides of a plate 22 after it has been sprayed at the first and second spraying stations 7, 8. The nozzles 91 are located such that when a plate 22 enters the washing station 8, the nozzles are positioned at an uppermost region of the plate. Thus, the aqueous medium is applied from above the plate 22 to both sides of the plate so that the aqueous medium flows along surfaces of the plate under gravity towards lower regions of the plate in a “waterfall flood” action. In this manner, any particles or contaminants that may have loosened and re-attached to the plate during the spraying cycles are removed. Preferably, large volume of the aqueous medium is supplied though the nozzles 91 at a low pressure. The plate 22 is washed in accordance with a pre-determined washing cycle using water or aqueous medium such as filtered mains water or purified or distilled water. The washing cycle is controlled by the electronic programmable controller. The nozzles 91 may be controllably movable to further improve access by the aqueous medium to all the areas to the plate which require washing.

The rinsing station 11 is located downstream of the washing station 9. The rinsing station 11 has a plurality of nozzles 101 provided at each side of the conveyor 4 for rinsing both sides of a plate 22 after it has been washed. The nozzles 91 are arranged so as to apply aqueous medium to all plate surfaces when a plate 22 enters the rinsing station 11, thereby eliminating any remaining chemical and/or particle contaminants. The aqueous medium is used in lower quantities than during the washing cycles and is applied in the form of low pressure pulsatory jets. The rinsing cycle is controlled by the electronic programmable controller. The nozzles 101 may be controllably movable to further improve access by the aqueous medium to all the areas of the plate which require rinsing.

Water, including mains water, may be used for creating the aqueous spays and for the washing and rinsing cycles, but the invention is not so limited. Other liquids or aqueous or non-aqueous media or solution can be used.

The system 1 also comprises an arrangement (not shown in the drawings) for recycling the water or any other aqueous medium used in the spraying and washing cycles. The arrangement comprises a collector manifold for collecting the aqueous medium from the first and second spraying stations 7 and 8 and from the washing station 9. The collector manifold is connected to an overflow reservoir or a tank in which the used aqueous medium is accumulated. The tank is connected to a supply of fresh water which is mixed with the used water in the tank and prevents the water from becoming stagnant. The tank is connected to a return manifold which supplies the nozzles 71, 81, 82 and 91 so that the mixed water from the tank is used in subsequent cycles. The tank has an open top through which the water overflows into a drain thereby preventing the water in the tank from becoming stagnant.

In one arrangement, a filter may be placed in the line between the collector manifold and the overflow reservoir to remove from the used water any debris collected by it.

For the rinsing cycle it is most preferred to use purified water which has been treated to render it free from minerals, dissolved gases and/or biological contaminants. This water is used only once and is not recycled.

The system of the invention also automatically dries wet process plates after the rinsing has been completed. The blower station 12 is located downstream of the rinsing station 11 and utilizes electronically controlled motor/blower heads 102 which produce large volumes of air in form of “air-knives” required to dry a plate 22 without using relatively expensive compressed air. Due to the large volume of air produced by the station 12, wet complex-shaped plates or trays can be dried efficiently and at a high rate. The “air-knives” also physically displace and remove drops of aqueous medium from the plates thereby further assisting the drying process. Heat may optionally be supplied to accelerate the drying process. An existing method of drying process trays comprises a combination of drip drying the trays and manually placing them in an oven. The problem of this existing method is low productivity and variability of tray dryness. The blower system overcomes the problem associated with the existing method.

It will of course be understood that the invention is not limited to the specific details described herein, which are given by way of example only, and that various modifications and alterations are possible within the scope of the invention.

1. A system for removing debris including stray contact lenses adhered to process trays comprising:
a first and a second spray means for supplying aqueous spray, each of the first and second spray means being positionable in the proximity of a process tray to be cleaned;
a first regulation means for regulating the pressure of the aqueous spray supplied by the first spray means so that the aqueous spray is applied to the tray at a first lower pressure;
a second regulation means for regulating the pressure of the aqueous spray supplied by the second spray means so that the aqueous spray is applied to the tray at a second higher pressure;
the combination of the lower pressure and higher pressure sprays being sufficient to disturb and remove debris, including stray contact lenses adhered to the tray.

2. A method of removing debris including stray contact lenses adhered to process trays comprising the steps of:
a. directing aqueous spray supplied from a first spray means at a first lower pressure towards surfaces of a process tray to be cleaned;
b. directing aqueous spray supplied from a second spray means at a second higher pressure towards surfaces of a process tray to be cleaned;
c. disturbing and removing debris such as stray contact lenses adhered to the tray with the combination of the lower-pressure and the higher-pressure aqueous sprays away from the tray.

3. A method as claimed in claim 2, comprising the step of enabling hydration of a dried debris adhered to the tray with the lower-pressure sprays thereby assisting in breaking the adhesion between the debris and the tray.

4. A method as claimed in claim 2, comprising the step of moving at least one of the first and second spray means so as to ensure access by the aqueous spray to all the areas of the tray which require cleaning.

5. A method as claimed in claim 2, comprising maintaining the spray supplied by the first spray means at the first lower pressure using a first pressure regulation means, and maintaining the spray supplied by the second spray means at the second higher pressure using a second pressure regulation means.

6. A method as claimed in claim 2, comprising the step of using at least one nozzle to apply the first lower pressure spray to a first side of a tray and at least one nozzle to apply the first lower pressure spray to a second side of the tray.

7. A method as claimed in claim 2, comprising the step of applying the first lower pressure spray to a pair of opposing sides of a tray simultaneously.

8. A method as claimed in claim 2, comprising applying the second higher pressure spray firstly to a first side of a tray using a first nozzle and moving the first nozzle relative the first side of the tray so as to direct spray towards all areas to be cleaned on the first side, and applying the second higher pressure spray to a second side of a tray using a second nozzle and moving the second nozzle relative the second side of the tray so as to direct spray towards all areas to be cleaned on the second side.

9. A method as claimed in claim 2, comprising the step of washing the trays upon the removal of the debris in accordance with a pre-determined washing cycle using a first source of aqueous medium.

10. A method as claimed in claim 9, comprising the step of applying the aqueous spray to an uppermost region of the tray so as to enable subsequent flow of the aqueous medium along surfaces of the tray under gravity towards lower regions of the tray thereby removing any particles or contaminants which may have attached to the tray during upstream processes.

11. A method as claimed in claim 9, comprising maintaining the aqueous medium supplied by the first source at a third lower pressure using a third pressure regulation means, and using at least one nozzle to apply the aqueous medium at the third lower pressure to a first side of a tray and at least one nozzle to apply the aqueous medium at the third lower pressure to a second side of the tray.

12. A method as claimed in claim 11, comprising the step of applying the aqueous medium at the third lower pressure to a pair of opposing sides of a tray simultaneously.

13. A method as claimed in claim 9, comprising the step of rinsing the trays in accordance with a pre-determined rinsing cycle using a second source of aqueous medium thereby eliminating any remaining contaminants.

14. A method as claimed in claim 13, comprising maintaining the aqueous medium supplied by the second source at a fourth lower pressure using a fourth pressure regulation means, and using at least one nozzle to apply the aqueous medium at the fourth lower pressure to a first side of a tray and at least one nozzle to apply the aqueous medium at the fourth lower pressure to a second side of the tray.

15. A method as claimed in claim 14, comprising the step of applying the fourth lower pressure spray to a pair of opposing sides of a tray simultaneously.

16. A method as claimed in claim 13, comprising the step of moving a tray continuously from first spray means to second spray means, to the first source of aqueous medium and to the second source of aqueous medium.

17. A method as claimed in claim 2, comprising the step of placing a tray on a tray support means in an upright orientation on a conveyor movable through a cleaning zone.

18. A method as claimed in claim 2, comprising:
collecting used aqueous medium;
directing the collected aqueous medium to an overflow reservoir;
supplying fresh aqueous medium into the reservoir so that the used and the fresh aqueous media mix in the reservoir; and
causing the mixed aqueous media to exit the reservoir into a return manifold for recycling the aqueous medium in a subsequent cleaning cycle.

19. A method as claimed in claim 18 comprising the step of controlling the mix of fresh and used medium in the reservoir.
